(19) United States
(12) Patent Application Publication
(10) Pub. No.: US 2016/0109967 A1
(43) Pub. Date: Apr. 21, 2016

(54) STYLUS

(71) Applicant: Scriba Stylus (IP) Limited, Belfast (GB)

(72) Inventor: David Howie Craig, Dublin (IE)

(21) Appl. No.: 14/867,744

(22) Filed: Sep. 28, 2015

(30) Foreign Application Priority Data
Oct. 16, 2014 (GB) 1418387.5

(51) Int. Cl. G06F 3/0354; G06F 3/01

(52) U.S. Cl. CPC G06F 3/03545; G06F 3/016

(57) ABSTRACT

A stylus comprises a first part extending longitudinally from a proximal end to a distal end, the distal end being arranged to provide a tip for engagement with a touch screen device. A second part is moveable relative to the first part to vary a transverse displacement of the second part relative to the first part. A sensor incorporated within the first part and arranged to provide an output signal indicative of the displacement; and electronic circuitry is arranged to provide a signal to the touch screen device based on the sensor output signal.

### RELATED APPLICATIONS

This application claims priority to UK patent application number 1418387.5, filed Oct. 16, 2014, the disclosure of which is incorporated herein by reference in its entirety.

### FIELD OF THE DISCLOSURE

The present disclosure relates to a stylus and in particular a stylus arranged to communicate with a touch screen electronic device.

### BACKGROUND

In the present specification, the term touchscreen device includes any host electronic device that may, for example include: a laptop computer; tablet computer (tablet); mobile phone; personal digital assistant (PDA); display screen, or other portable or non-portable electronic device.

A common use of a stylus is to provide position input to a computer drawing or handwriting application in lieu of finger touch on a touch screen device. For such an application, the stylus may be used, for example, to draw lines, move or size screen objects, and to interact with the user interface.

Basic stylus designs are ‘passive’ in that they include no electronic components and simply provide a more precise pointer than a human finger.

Typical active, pressure sensitive styluses include on-board sensors and electronics to measure and wirelessly communicate to a touch screen device the amount of pressure being applied by a stylus tip to the touch screen (as well as information in relation to the state of stylus buttons or other sensors). The amount of pressure applied to the touch screen can then be processed by the touch screen device to, for example, display on the touch screen a wider or narrower line at the stylus tip location or to provide other functionality depending on the application running on the touch screen device.

This makes sense in principle; however, the tactile sensation of pressing a firm stylus tip into a glass (or equivalent) screen with differing levels of pressure has not proved satisfactory. While such styluses can offer very high accuracy measurement of tip pressure for example up to 4048 levels of sensitivity, the range of pressure is hard for a user to gauge or replicate because there is so little movement or tactile feedback. This has limited the uptake of pressure sensitive styluses.

As a supplement to measuring tip pressure, an active stylus, the YuFu Pro (http://hex3.co/yufu-stylus/yufu-pro-pressure-sensitive-stylus-silver/) includes a pressure sensor and a separate button incorporated within the body of the stylus and the signals from these can be used for operation with a compatible application. However, the form factor of this stylus again limits the utility of the stylus to the user.

### SUMMARY

According to the present invention there is provided a stylus comprising: a first part extending longitudinally from a proximal end to a distal end, the distal end being arranged to provide a tip for engagement with a touch screen device; a second part moveable relative to the first part to vary a transverse displacement of said second part relative to said first part; a sensor incorporated within the first part and arranged to provide an output signal indicative of said displacement; and electronic circuitry arranged to provide a signal to said touch screen device based on said sensor output signal.

Preferably, each of said first and second parts are integrally formed.

Preferably, each of said first and second parts are formed of a plastics material.

Further preferably, each of said first and second parts are injection molded.

Alternatively, each of said first and second parts are formed separately.

Preferably, said second part is moveable from a reference location when no pressure is applied by a user to said first and second parts through a range of displacement locations.

Preferably, each of said first and second parts define a void therebetween and movement displaces said second part into said void.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

Various embodiments of the present invention will now be described, by way of example, with reference to the accompanying drawings, in which:

FIG. 1 is a side view of a stylus according to a first embodiment of the present invention;

FIG. 2 is a first perspective view of the stylus of FIG. 1;

FIG. 3 is a second perspective view of the stylus of FIG. 1;

FIG. 4 is a perspective view of the stylus of FIG. 1 operating with a touch-screen device;

FIG. 5 is an exploded view of the stylus of FIG. 1;

FIG. 6 is a side view of a stylus according to a second embodiment of the present invention; and

FIG. 7 is a first perspective view of the stylus of FIG. 6.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

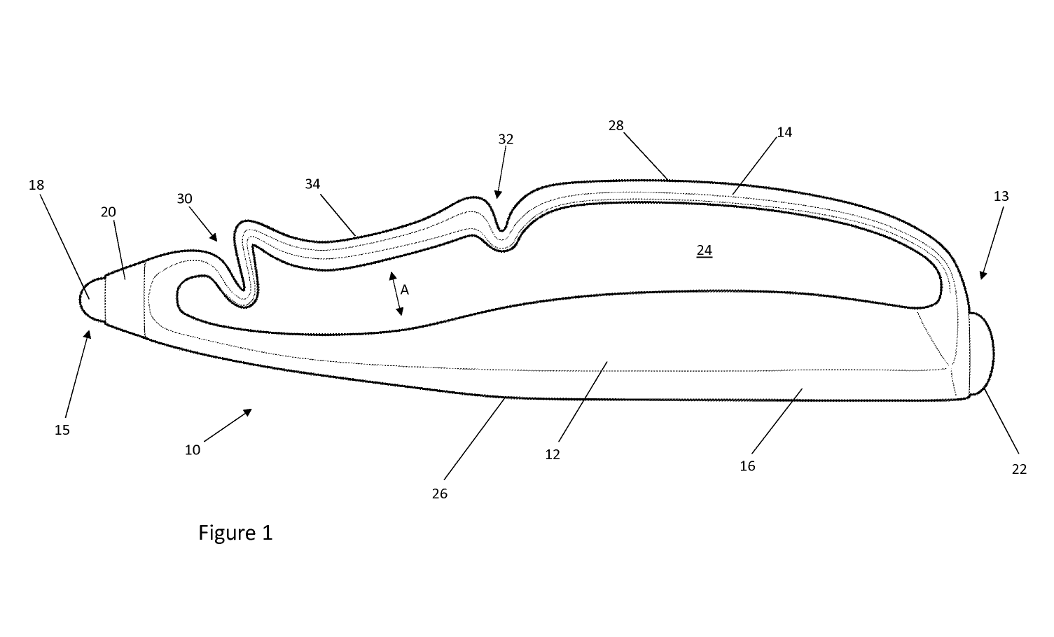

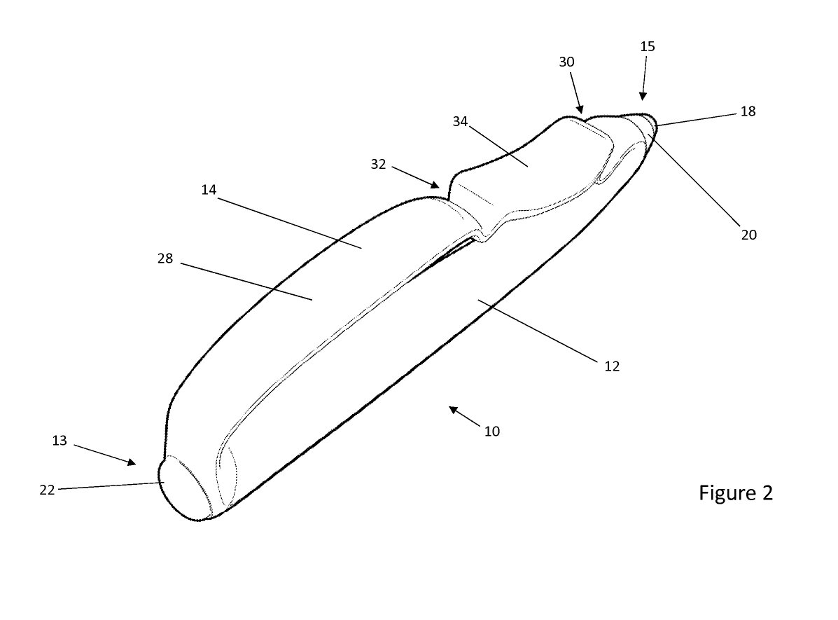

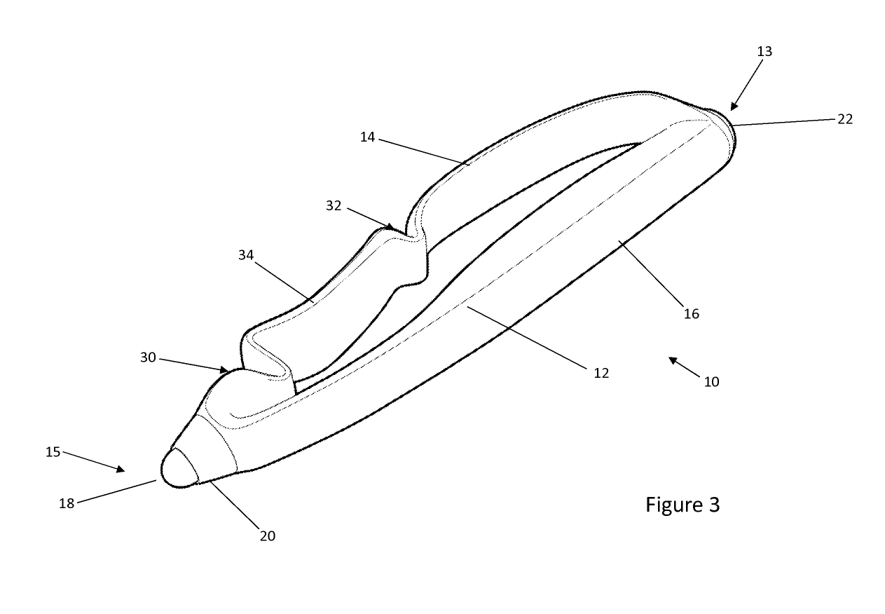

Referring now to FIGS. 1-3, there is shown a stylus 10 for a touch-screen device according to a first embodiment of the present invention. The stylus comprises a two part body including a relatively rigid part 12 and a moveable part 14 which is at least partly moveable relative to the rigid part.

In the embodiment, the rigid part 12 incorporates active electronic circuitry including a sensor, processing and communications circuitry discussed in more detail later. Movement of the part 14 relative to the part 12 is sensed and measured by the sensor and this movement is converted by the remainder of the electronic circuitry into a signal for communication to the touch-screen device for use by the operating system or an application running on the device as outlined in more detail below.

In the first embodiment, the rigid part 12 is generally longitudinal in form and extends from a proximal end 13 towards a distal end 15 of the stylus.

A removable hollow tip 18 is fitted within a collar 20 which in turn fits to the distal end of the stylus. The tip 18 shown comprises a generally hemispherical outer surface, however, it can be interchanged with tips or even brushes having different characteristics or profiles according to the user's preference or dependent on the type of screen technology.

A removable cap 22 is fitted to the proximal end of the stylus and when removed provides access to the electronic circuitry for the stylus so that at least the battery can be changed.

Each of the cap 22 and tip 18 is formed of a rubberized type of material. In some cases, the material can be electrically conductive, in particular that of the tip.

The moveable part 14 connects to the rigid part 12 adjacent each of the distal and proximal ends and extends between the two ends to define a void 24 between the two parts 12, 14.

The rigid part 12 has an outer surface 16 curving about the longitudinal axis of the part 12. An inflection 26 is defined at a mid-point along the length of the outer surface to provide a generally convex longitudinal as well as transverse profile and this outer surface 16 provides an ergonomic shape suitable for enabling the stylus to engage comfortably either a user's thumb or forefinger and to rest on the first interphalangeal web of the user's hand.

The moveable part 14 is generally oblong in transverse section and extends so as to present a ribbon-like outer major surface 28, extending between the proximal and distal ends of the stylus.

A pair of transverse indentations are defined in the part 14 to define live hinges 30 and 32 respectively. (In alternative embodiments, active hinges could be used.) One hinge 30 is defined adjacent the distal end of the stylus and the second hinge 32 is defined towards the middle of the stylus. A section 34 between the hinges 30, 32 provides a generally concave longitudinal external profile suitable for receiving either a thumb or forefinger of a user, according to the way the user chooses to orient the stylus 10 in their hand.

The hinges 30 and 32, the cross-sectional profile of the part 14, as well as the material forming the moveable part 14 enable a user engaging the stylus between their thumb and forefinger to squeeze the stylus and so selectively displace the moveable part 14 from an equilibrium reference location disposed away from the rigid part 12, towards the rigid part 12.

The material forming the moveable part is as well as the profile of the part 12 provide resilience so that when a user removes pressure from the part, the part 14 tends to return to the un-deformed reference location.

The movement along the path A shown in FIG. 1 is sensed by a sensor incorporated within the rigid part 12 which can then determine the relative displacement of the moveable part 14 with respect to the rigid part 12.

This displacement can be converted into an electronic signal which can be transmitted to a touch screen device for use by an application running on the device.

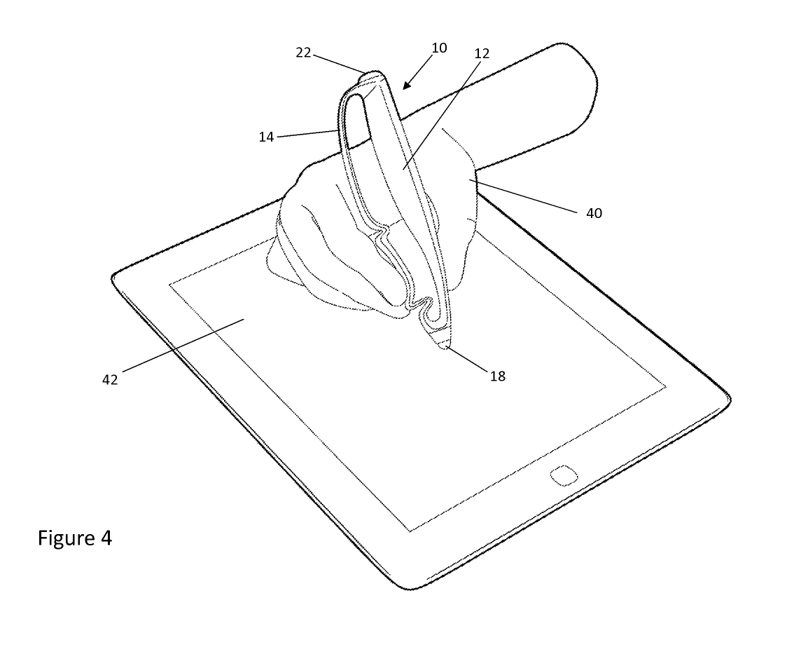

FIG. 4 shows the stylus in use and being held in a user's hand 40 with the tip 18 of the stylus disposed against the surface of a touch-screen device 42.

In this case, the user is resting the rigid part 12 on the first interphalangeal web of the hand and is engaging the moveable part 14 with their forefinger. As explained, other users may choose to invert this arrangement and indeed the stylus can be used with many different types of grip.

It will be seen that it is possible for the user to vary the transverse pressure on the stylus between their thumb and forefinger as they are drawing or writing with the stylus in an intuitive fashion, so enabling the user to for example, define lines of varying width as they are being drawn.

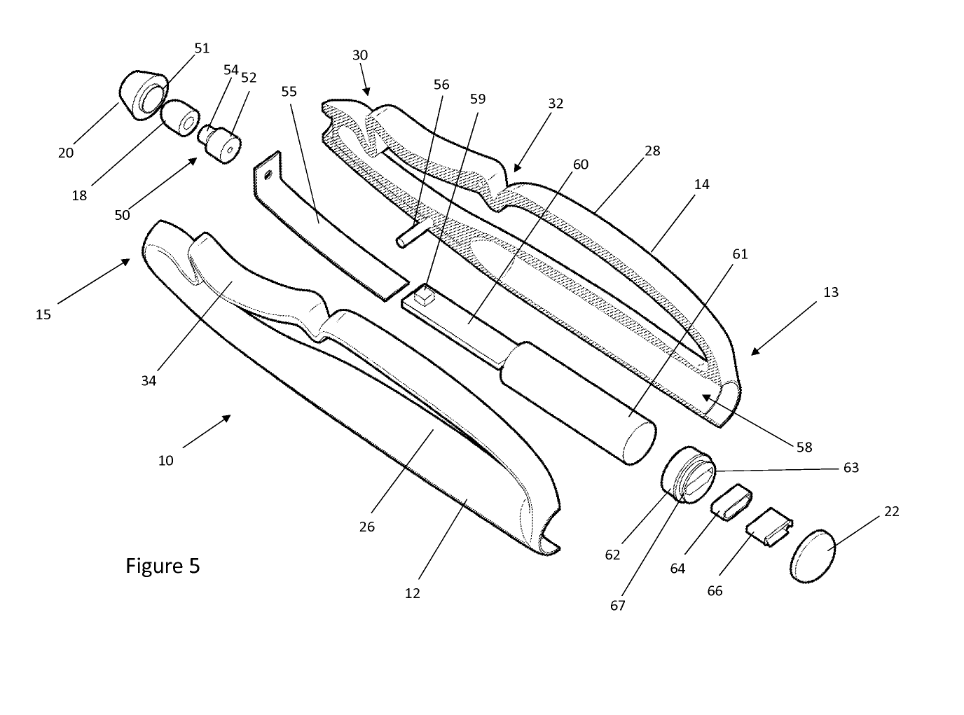

Turning now to FIG. 5 which is an exploded view illustrating the construction of the stylus 10.

In this embodiment, the body of the stylus is injection molded from a suitable plastics material to enable the moveable part 14 to flex resiliently relative to the fixed part 12.

A number of components for the stylus can be inserted in the mold prior to injection of the plastics material while others can be fitted after molding. A tip holder 50 comprises a generally cylindrical base 52 with a narrowed head 54 extending towards the distal end of the stylus. The narrowed head is dimensioned so that, after molding, a hollowed tip 18 can be push fitted over the head. The base 51 of the collar 20 is shaped or machined so that when a tip 18 (or other compatible accessory) is located on the tip holder, the collar can in turn locate over the tip and connect with the tip holder 50 to secure the tip 18 in place. Thus the collar and tip holder could be screw threaded, or otherwise profiled or magnetized to allow the tip holder 50 and collar 20 to lock together. Some tips, such as a brush tip (not shown), might comprise a combined collar and tip which fit and secure to the tip holder 50 in a single movement rather than being fitted separately as with the tip and collar 18, 20.

As well as the tip holder 50, a conductive metal strip 55 is located in the mold extending from behind the tip holder 50 along the length of the rigid part to a mid-point of the rigid part. In the present implementation, the end of the strip 55 is bent and fixed to the tip holder, for example, by welding or bonding, prior to insertion of the assembly into the mold. The strip 55 provides the required rigidity to the distal end of the rigid part 12, which narrows in cross-section relative to the proximal end. Nonetheless, it will be appreciated that there are many other possible techniques for providing the required rigidity.

Some tips which might be employed with the stylus could require an electrical connection to the PCB 60. This could be provided via the strip 55 or by any suitable mechanism such as cabling or a metal ribbon. In still further embodiments, where the material comprising the body of the stylus or portions of the body of the stylus is electrically conductive, the connection can be provided via the body.

It will also be appreciated that the body can be either fully or partially conductive and preferably, the body is conductive at least at the points on the body which are held by the user in order to create an electrical path from the host electronic device through the user to ground.

A magnet 56 is also located in the portion of the mold which will define the moveable part 14 of the stylus. In the example, the magnet 56 comprises a rod extending transversely within the mold and disposed close to the hinge 32. In alternative embodiments, a disc magnet (not shown) orientated with the normal of the disc extending transversely within the mold can be employed. However, it will be appreciated that the magnet can be any suitable shape. As well as locating the magnet 56 close to or at the point of most displacement of the moveable part 14 relative to the rigid part 12, the location of the magnet 56, also makes it possible to readily locate a sensor 59 within the rigid part juxtaposed the magnet 56 as will be explained.

Finally, during manufacture a removable generally cylindrical draw (not shown) is placed in the mold to define a corresponding cavity 58 within the molded rigid part 12. When the molded stylus is removed from the mold and the draw removed from the molded stylus, a PCB 60 on which the sensor 59 as well as processing and communications circuitry (not shown) is mounted or can be positioned within the cavity provided. The PCB 60 extends longitudinally from the bottom of the cavity 58 defined by the draw towards the proximal end of the stylus with the sensor 59 located towards the bottom of the cavity and juxtaposed the magnet 56. The end of the PCB 60 opposite the sensor 59 includes battery contacts (not shown) and these allow a battery 61, for example of the AA type, to be inserted into the cavity and to contact the PCB battery contacts to supply power to the PCB 60. It will be appreciated of course that any suitable battery could be used. Thus, in alternative embodiments, a flat rechargeable battery might be employed and this could be located on the underside of the PCB.

Once the battery 61 and PCB 60 are installed within the cavity 58, they are maintained in position with a cap 62 which fits into the mouth of the cavity 58. The cap can push fit into the mouth to seal the cavity or it can screw or bayonet fit into the mouth of the cavity or indeed fit into the cavity with any suitable means.

It will be noted that the longitudinal arrangement of the strip 55, PCB 60 and battery 61 within the part 12 contribute to maintaining the shape of the part 12.

The cap 62 includes a transverse slot 63 which is arranged to receive an insulator or isolating ring 64; and, in turn, a micro-USB port 66 is fitted within the insulator ring 64. The cap 62 also incorporates a raised peripheral lip 67, so that the cap 22 can be securely fitted to the cap 62 and so cover the micro-USB port 66.

With the cap 22 removed, a user can connect a charger (not shown) or charging cable to the micro-USB port 66 which in turn is electrically connected to the PCB 60 and battery 61 to re-charge the battery where the battery 61 is of the re-chargeable type. A reset button (not shown) could also be incorporated under the cap 22 to provide a hard reset function. Indeed, a button (not shown) could also be incorporated under the cap 22 to provide additional functionality.

In variations of the embodiment, the stylus could include energy harvesting or scavenging circuitry (not shown), for example, to allow the device to be charged kinetically or inductively either as an alternative or a supplement to the battery 61. The stylus 10 is particularly suited to kinetic or induction charging as its form factor lends itself to being carried about in a user's pocket when not in use.

It will be appreciated that in variants of the illustrated embodiments, connections other than a USB type connection can be employed. In any case, the connection can be used both to enable charging of a battery (if present), but also data communication with the stylus. For example, the connection could be used in order to enable the stylus to receive software or firmware updates. Alternatively, updates could be provided by a wireless connection such as a Bluetooth connection between the stylus and host electronic device.

In the embodiment, the sensor 59 comprises a Hall Effect sensor whose output varies as a function of the distance of the magnet 56 from the sensor 59. Thus, when in use, as a user squeezes the moveable part 14 towards the rigid part, the sensor 59 can provide an indication of the relative position of the two parts and so the extent of displacement from the reference location.

It will nonetheless be appreciated that any combination of sensor and stimulus could be provided to enable detection of the displacement of the moveable part 14 relative to the rigid part 12.

It will also be appreciated that in alternative embodiments, indirect measurement of movement between the parts 12 and 14 could also be employed as an alternative or in addition to directly sensing the movement of the stimulus, in this case the magnet 56, relative to the sensor 56. For example, in some embodiments, a strain gauge (not shown) could be integrated within the stylus body at either the proximal or distal ends of the stylus where the parts 12, 14 meet. Flexing of the part 14 relative to the part 12 would provide a variation in strain, so providing a signal indicative of the movement of the part 14 relative to the part 12.

In the embodiment, the range of movement of the part 14 relative to the part 12 is in the range of approximately 4-16 mm and more preferably 8-12 mm, which provides a user with a much greater range of movement and so control than in tip based or direct pressure sensors of the prior art. Because this degree of deformation of the device is visible, it adds visual as well as tactile feedback, indicating the amount of pressure being applied by the user.

The output signal from the sensor 59 is connected to conventional type processing circuitry located on the PCB 60 which in turn is arranged to communicate the signal wirelessly via communications circuitry to the touch screen device. As the signal indicating the amount of squeezing and so movement between the parts 12, 14 corresponds to the amount of pressure that otherwise would have been applied through the tip to the screen, the stylus 10 can appear as a standard device and so conventional processing and communications circuitry can be employed and so these are not described in further detail here.

An application running on the touch screen device can synchronise the pressure signal derived from the sensor 59 with positional data determined from sensing the location of stylus tip 18 on the touch screen 42 to drive any touch screen application as required.

The squeeze pressure signal from the sensor 59 will be accepted as user input and depending on the selected application may control a number of number of variables such as varying the thickness of a rendered line, colour values or selecting a particular user input such as opening a particular function in the user interface.

When drawing a line, the variation in pressure between the parts 12 and 14 can change relatively slowly. However, the stylus processing circuitry could also be arranged to respond to quicker changes in pressure, for example, a “click” can be defined as comprising a substantially full depression of the part 14 lasting 100 ms or less. Such quick changes could be converted to discrete commands such as click, double-click or click-and-hold and transmitted to the touch screen device for use by a running application.

It will be seen that by moving the measurement of pressure away from the tip of the device as in the prior art, the construction of the tips 18 for the stylus can be much simpler and the range of tip types that can be used greater as tips are not required to transfer pressure measurement to the pressure sensor 59. Any tip fitted to the stylus can be registered by the touch screen device so that an application running on the device can respond accordingly, for example, by changing the display from rendering lines to brush strokes when a user changes from a solid tip such as the tip 18, to a brush tip (not shown). In any case, a user can employ any type of tip to suit the type of work that the user wishes to do.

Nonetheless, it will be appreciated that in variations of the above described embodiment, a tip pressure sensor could be added as a supplement to the transverse pressure sensor 59 described above to expand the functionality of the stylus.

Still further variations of the above described embodiment are also possible.

For example, further sensors may incorporating with the stylus to provide additional functionality. For example, the PCB 60 could incorporate one or more of the following: accelerometer, gravimeter, gyroscope, magnetometer, MEMs sensor, proximity sensor, and so forth.

Any sensor which indicates the stylus orientation can be used (in conjunction with any orientation sensors contained within the touch screen device itself) to indicate the orientation of the stylus relative to the touch screen drawing surface.

So, for example, traditionally there are a number of ways of holding a drawing instrument that correspond to the type of drawing. Traditionally sketching and writing involves holding a pen at an angle of approximately 45 degrees to the page, whereas in technical drawing (which would commonly involve a straight edge) the pen would be held at an angle of closer to 90 degrees to the page. A third convention in traditional drawing is the use of an eraser affixed to the opposite end of a pencil or pen for removing parts of the drawn image.

Thus orientation information allows the touch-screen device to operate in a number of different modes according to how the stylus is being held and used. In a first sketching or writing mode, the stylus is held at an angle up to around 45 degrees relative to the screen; in a second drawing mode, the stylus is held at around 90 degrees for the equivalent of hard line drawing; and in a third mode, where the orientation is approximately −90 degrees to the surface, the secondary tip is employed in an erasing mode.

The user can also employ gestures, for example, a twist/shake movement of the stylus that can be sensed by orientation sensors incorporated with the stylus. The signals produced by sensors in response to these gestures can either: be interpreted by the stylus processing circuitry and transmitted to the touch-screen device as discrete commands; or the signals can be transmitted directly to the touch-screen device for interpreting. In any case, such gestures can be employed by a touch screen application to invoke other functionality, such as undo, clear, etc., or to interact with other types of wirelessly connected device.

Alternative type functionality might involve a user fully squeezing the part 14 against the part 12 for say more than 2 seconds. A command based on this gesture might cause the touch screen device application to for example, lock a line width. Nonetheless, line lock can be induced by simply holding the level of pressure largely consistently at any pressure level.

The touch screen application might also combine stylus interaction including stylus location and pressure information, with the use of a finger touch on a predefined point on the touch screen to generate other commands.

Also, for a non-centrally symmetric tip, for example, a chisel tip, an orientation sensor could assist the touch-screen device in tracking the change in orientation of the stylus, to update a rendered line accordingly.

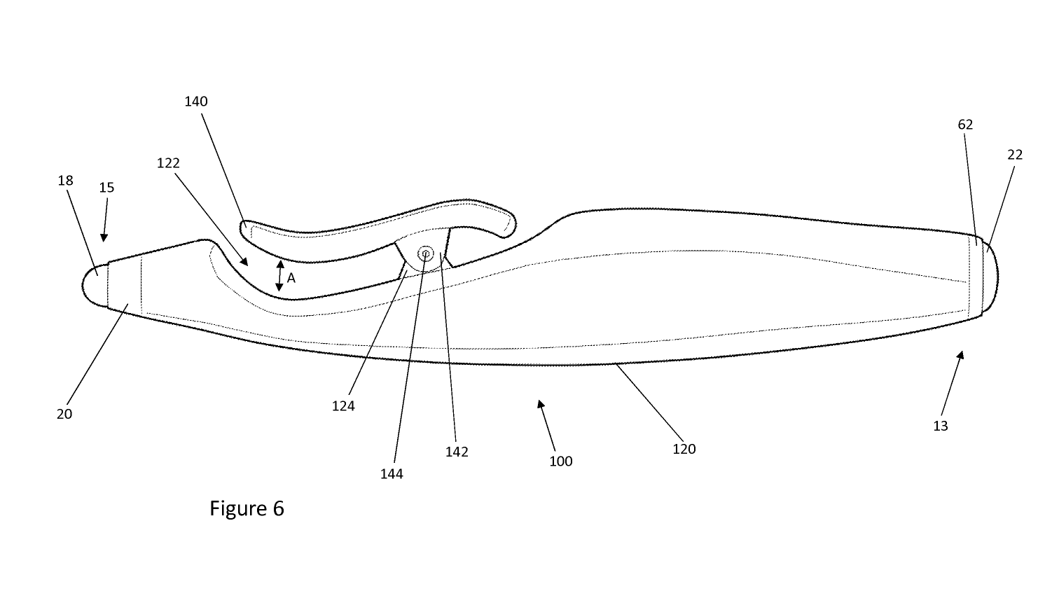

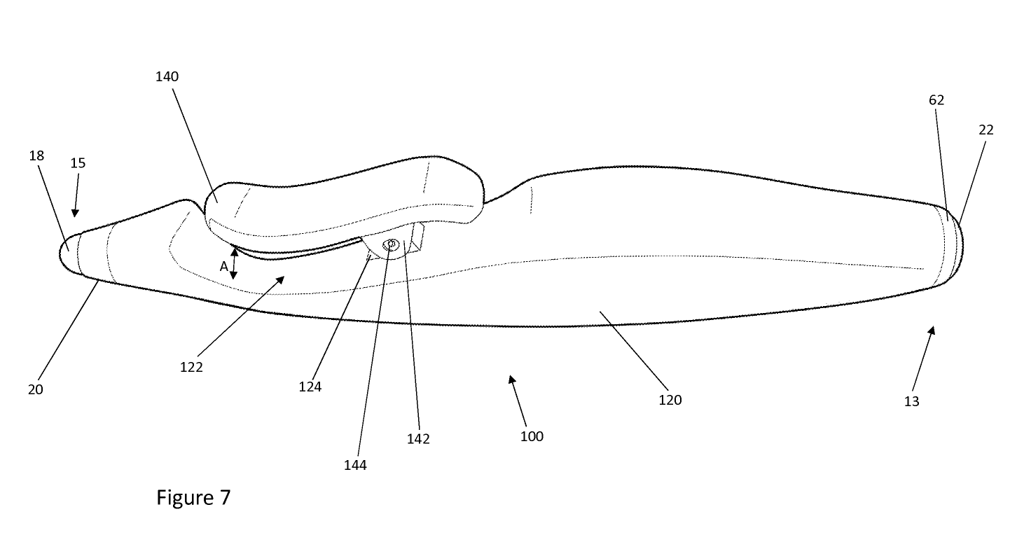

Referring now to FIGS. 6 and 7, there is shown a stylus 100 according to an alternative embodiment of the present invention. In FIGS. 6 and 7, like numerals have been employed to indicate similar parts to the embodiment of FIGS. 1-5.

In the embodiment of FIGS. 6 and 7, the stylus 100 comprises a rigid part 120 in which a hollow 122 is formed in one side. A fulcrum 124 extends from the surface of the part 120 within the hollow 122. A moveable part 140, comprising an ergonomically shaped lever, is formed separately from the rigid part 120. A pair of spaced apart legs 142 extend from the underside of the lever and when the lever is located within the hollow 122, the legs 142 straddle the fulcrum 124. A bolt 144 passes through a transverse channel formed in the legs and fulcrum and enables the moveable part 140 to pivot relative to the rigid part 120 about the transverse axis of the bolt 144. The overall profile of the part 120 tapers away from a widened center portion towards each of the distal and proximal ends (so that it has a fatter center portion). When fitted within the hollow 122, the external surface of the lever generally conforms with the overall profile of the stylus when in a reference location. A spring can be located between the parts 120 and 140 to bias the parts 120, 140 towards the reference location with the distal end of the lever spaced apart from the fixed part 120. Alternatively, the bolt could comprise an integral torsion spring.

As in the embodiment of FIGS. 1-5, a sensor, electronics and possibly a battery are located in the fixed part in a cavity closed off by the caps 62, 22. Again, the sensor is arranged to detect displacement of the moveable part 140 in both directions along the path A. Again, this can be achieved by incorporating a magnetic element within the lever towards its distal end and using a Hall Effect sensor (not shown).

This movement corresponds with the movement of the part 14 relative to the part 12 in the embodiment of FIGS. 1 to 5 and so the remaining electronic implementation of the embodiment of FIGS. 6 and 7 corresponds with the embodiment of FIGS. 1 to 5 mutatis mutandis.

Still further variants of the above described embodiments are possible. So for example, an adjusting or tightening mechanism can be incorporated in any embodiment of the stylus to allow the sensitivity or the ‘weight’ associated with the relative movement of the parts 12, 14 or 120, 140 to be adjusted.

While the embodiments illustrated above have been described in terms of an injection molded plastics body, the stylus body could also be machined from a solid piece of material including metals such as aluminum. Alternatively, resin material or carbon-fibers or metal ribbon could be incorporated within a composite stylus body.

The styluses of the illustrated embodiments are arranged to accommodate a variety of hand sizes including those of children; and so a standard sized stylus can be provided to suit up to 80% of users' hand sizes.

Styluses according alternative embodiments may also include one or more user actuable switches including an on/off switch or indeed a switch which can be used to indicate a user input to any compatible touch-screen device application.

Otherwise a discrete on/off switch may not be required as for example, a double “click” of the part 14 or 140 (as described above) can be used to turn the stylus on from a standby or sleep state, and after a period of inactivity, the stylus can turn off. Alternatively, pressing and holding for a period of time such as 1 second, double-clicking or triple clicking could also be used.

In still further variants of the above described embodiments, the stylus could comprise a vibration mechanism (not shown) located on the PCB 60 and which bears against the body 12. The mechanism can be actuated, for example, to provide haptic feedback for a user for example, in order to signal to the user how much pressure they are applying; or indeed for any application specific purpose.

For example, the range of movement of the part 14 could be divided into multiple, for example, 3 ‘zones’ and a pattern of the buzz, double-buzz or other pattern of the vibration mechanism could be used to indicate movement from one ‘zone’ to the next.

The stylus can be distributed as a stand-alone universal device or alternatively, the stylus could be distributed with software comprising a library of functions for use within a software development kit (SDK), enabling developers to write applications utilising any expanded functionality of the stylus provided by the sensors and actuators described above.

Those skilled in the art will recognize improvements and modifications to the preferred embodiments of the present disclosure. All such improvements and modifications are considered within the scope of the concepts disclosed herein and the claims that follow.

What is claimed is:

1. A stylus comprising: a first part extending longitudinally from a proximal end to a distal end, the distal end being arranged to provide a tip for engagement with a touch screen device; a second part moveable relative to the first part to vary a transverse displacement of said second part relative to said first part; a sensor incorporated within the first part and arranged to provide an output signal indicative of said displacement; and electronic circuitry arranged to provide a signal to said touch screen device based on said sensor output signal.

2. A stylus according to claim 1 wherein each of said first and second parts are integrally formed.

3. A stylus according to claim 1 wherein each of said first and second parts are formed of a plastics material.

4. A stylus according to claim 3 wherein each of said first and second parts are injection molded.

5. A stylus according to claim 1 wherein each of said first and second parts are formed separately.

6. A stylus according to claim 1 wherein said second part is moveable from a reference displacement location when no pressure is applied by a user to said first and second parts through a range of displacement locations.

7. A stylus according to claim 1 wherein each of said first and second parts define a void there between and movement displaces said second part into said void.

8. A stylus according to claim 1 wherein the second part is adapted to receive a finger of the user to enable a user to selectively displace the second part.

9. A stylus according to claim 1 wherein the sensor comprises a Hall Effect sensor and the second part comprises a magnetic element.

10. A stylus according to claim 6 wherein the range of displacement of the second part relative to the first part is in the range of approximately 4-16 mm and preferably 8-12 mm.

11. A stylus according to claim 7 wherein the second part is connected to the first part adjacent each of the distal and proximal ends and extends between the two ends to define said void between the first part and the second part.

12. A stylus according to claim 11 wherein the second part comprises a first hinge to enable a user to selectively displace the second part.

13. A stylus according to claim 12 wherein the second part further comprises a second hinge, the first hinge and the second hinge defining a section of the second part for receiving the finger of the user.

14. A stylus according to claim 13 wherein one or more of: the hinges, a cross-sectional profile of the second part; and/or the material forming the second part, enable a user engaging the stylus to squeeze the stylus and so selectively displace the second part towards the first part.

15. A stylus according to claim 5 wherein the first part comprises a fulcrum, the second part comprises a pair of spaced apart legs and the stylus further comprises a component that passes through a transverse channel formed in the legs and fulcrum to enable the second part to pivot relative to the first part about a longitudinal axis of the component.

16. A stylus according to claim 6 wherein the material forming the second part and the profile of the second part are such to provide resilience so that when a user removes pressure from the part, the second part tends to return to the reference displacement location.

17. A stylus according to claim 1 wherein the second part is formed as a lever connected to the first part at a first end and comprising the magnet towards a distal end of the second part.

18. A stylus according to claim 1 further incorporating a vibration mechanism actuable to provide haptic feedback to a user.
